(19) United States
(12) Patent Application Publication
(10) Pub. No.: US 2011/0007883 A1
(43) Pub. Date: Jan. 13, 2011

(54) INTERCOM SYSTEM

(75) Inventors: Paul BINGHAM, Chippendale (AU); John Darlington, Chippendale (AU); Arne Hansen, Chippendale (AU); Jasen Hill, Chippendale (AU); David Jones, Chippendale (AU); Deb Noller, Chippendale (AU); Shane Richards, Chippendale (AU)

Correspondence Address: MORRISON & FOERSTER LLP, 12531 HIGH BLUFF DRIVE, SUITE 100, SAN DIEGO, CA, 92130-2040, US

(73) Assignee: Switch Automation Pty Ltd, Sydney (AU)

(21) Appl. No.: 12/771,966

(22) Filed: Apr. 30, 2010

(30) Foreign Application Priority Data
Apr. 30, 2009 (AU) 2009100404

(51) Int. Cl. H04M 11/00

(52) U.S. Cl. 379/93.17

(57) ABSTRACT

An entry station for an intercom system comprises a touch-screen user interface operable to facilitate a dialling function. A communications module is provided which is arranged to communicate with at least one destination terminal in accordance with the dialling function.

### TECHNICAL FIELD

This present invention broadly relates to an intercom system and more particularly, but not exclusively to, an intercom entry terminal arranged to communicate with at least one destination terminal for carrying out an audio and video call.

### BACKGROUND OF THE INVENTION

Typical intercom systems for residential and commercial installations usually include an entry station located at an entry point (e.g. a front door or gate) and one or more telephone handsets located in each residence or premises.

In smaller installations (e.g. including less than ten residences), the entry point will typically include a panel comprising a plurality of call buttons; each button being associated with a particular residence. For larger installations, a physical keypad is commonly provided on the front panel for allowing a visitor to place a call to a desired residence. Once the number of the residence has been entered into the keypad, a call signal is output from entry station which causes the corresponding residence handset to trill. Upon picking up the telephone handset (i.e. “answering” the call) a bi-directional channel is opened to facilitate two-way audio communications between the visitor and resident, thereby allowing the visitor to identify themselves. The resident may then press a button on their handset which causes a command signal to be sent to open a lock which allows the front door/gate to be opened by the visitor.

A disadvantage is that with communication via the keypad only, the visitor must know the number for the required residence or premises. In a large project or a commercial application where the visitor may not know the number there is a requirement to list a directory near the intercom with all of the associated numbers. Keeping this directory up to date can be challenging when residents or premises change hand frequently. Keypads are also prone to damage from exposure to the elements and vandalism. They are also unable to cater for complex door or gate release operations as is often required whereby a visitor may only gain access to the gates, doors, elevators, floors that the specific residence can allow.

### SUMMARY OF THE INVENTION

In a first aspect the present invention provides an entry station for an intercom system, the entry station comprising:
a touch-screen user interface operable to facilitate a dialling function; and
a communications module arranged to communicate with at least one destination terminal in accordance with the dialling function.

In an embodiment the touch-screen user interface comprises a projective touch-capacitive panel located behind a weatherproof shield. The water-proof shield may, for example, be a sheet of laminated glass.

In an embodiment the dialling function is the placing of a call to the destination terminal(s). In an embodiment the dialling function may additionally or alternatively include recording an audio and/or video message arranged to be subsequently played by the destination terminal(s).

In an embodiment the communications module is further arranged to carry out the video and/or audio call with the at least one destination terminal over an IP network. In an embodiment, Voice Over Internet Protocol (VOIP) is utilised to carry out the call.

In an embodiment the entry station communications with a communications server to obtain relevant routing information for calling at least one destination terminal.

In an embodiment the touch screen interface is arranged to display a directory including identification information for all destination terminals that are capable of communicating with the entry station. In an embodiment the identification information is obtained from a building management server. In an embodiment a user may select a particular directory listing to carry out the dialling function.

In accordance with a second aspect of the present invention there is provided an intercom system comprising:
an entry station in accordance with the first aspect; and
at least one destination terminal operable to communicate with the communications module over an IP communications network.

### BRIEF DESCRIPTION OF THE DRAWINGS

Embodiments of the present invention will now be described, by way of example only, with reference to the accompanying drawings, in which:

FIG. 1 is a schematic of an intercom system, in accordance with an embodiment of the present invention;

FIGS. 2a, 2b and 2c are schematic front, rear and end views respectively of the entry station illustrated in FIG. 1;

FIG. 3 is a process flow diagram, in accordance with an embodiment of the present invention; and

FIGS. 4a and 4b are example screen shots of the user interface.

### DETAILED DESCRIPTION OF THE PREFERRED EMBODIMENT

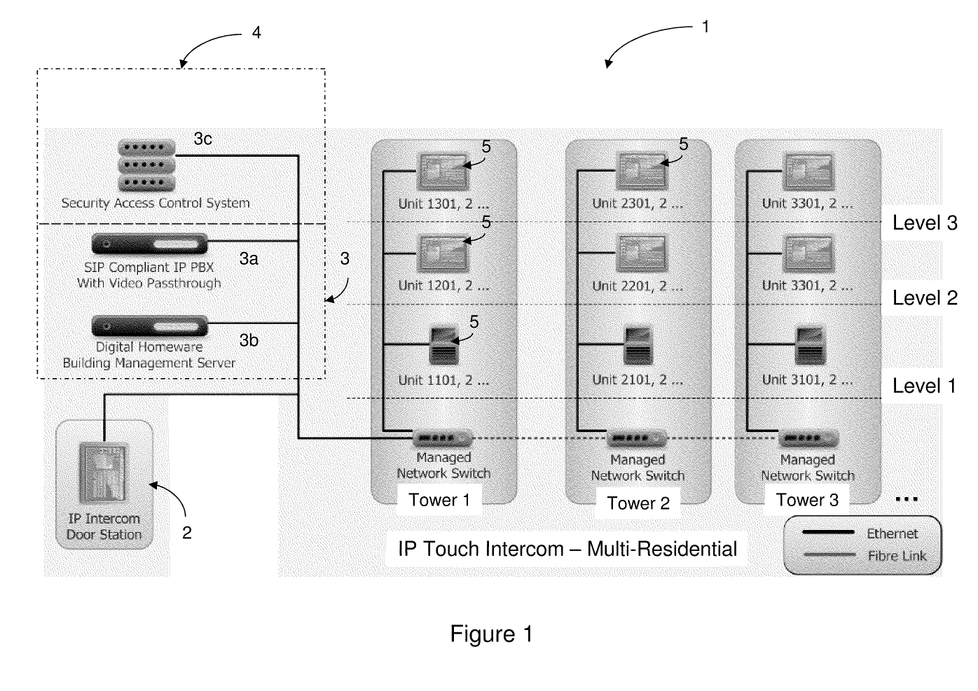

Referring to FIG. 1, there is shown an intercom system 1. The intercom system 1 comprises an entry station 2 in the form of a touch-screen user interface; a communications system 3; a security access control system 4; and a plurality of residence terminals 5 (in a variety of form factors). In the embodiment described herein, the various modules referred to above are coupled to one another via an Internet Protocol (IP) network and Voice over Internet Protocol (VOIP) is utilised to facilitate the handling of calls.

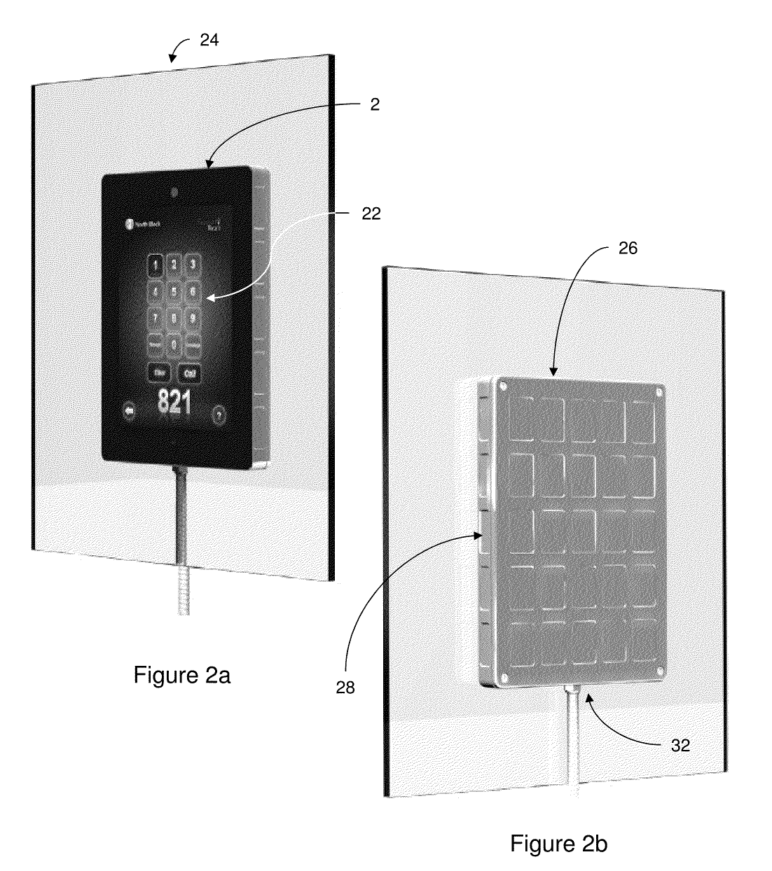

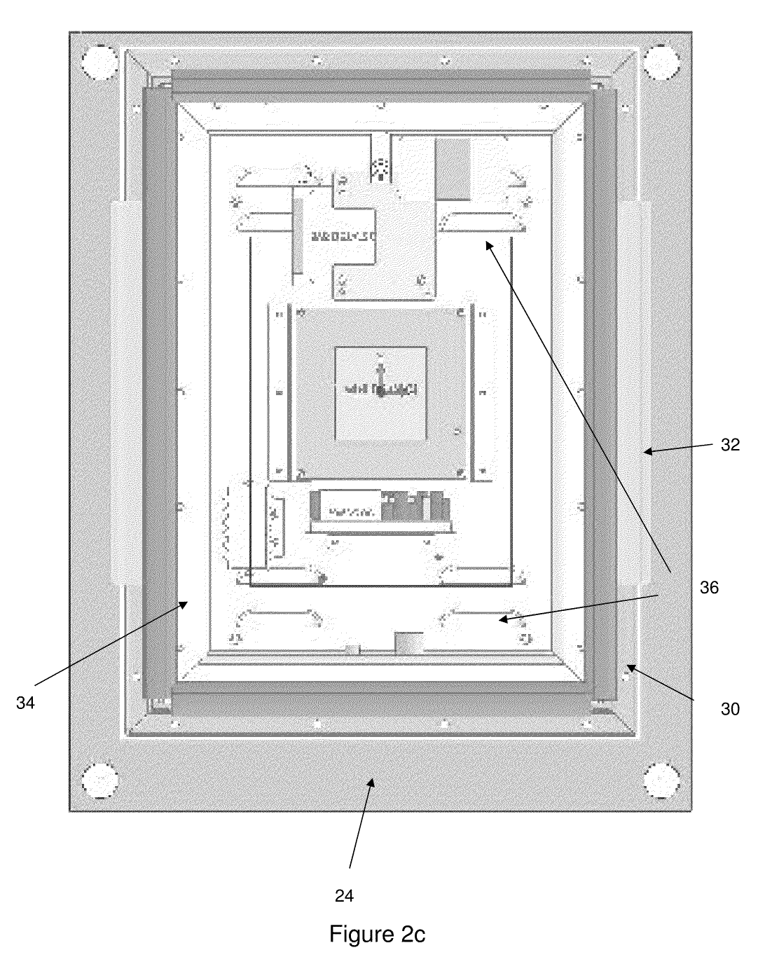

In more detail, and with additional reference to FIG. 2a, the entry station 2 is in the form of a touch-screen user interface. In accordance with the illustrated embodiment, the touch-screen interface 2 (hereafter “interface”) comprises a projective capacitive touch screen 22.

As persons skilled in the art will appreciate, projective capacitive screens include an array of sensing wires embedded within layers of a non-metallic material. When a conducting medium, such as a finger, touches the surface of the touch-screen sensor, a change in capacitance occurs. This results in a measurable oscillation frequency change in the sensing wires surrounding the contact point. An integrated control circuit can calculate and process the new capacitive values to translate the contact point to an absolute screen position. Because of the way projective capacitive technology works, the touch can be sensed through a protective layer in from of the actual touch-screen sensor, providing the various advantages detailed below.

The use of a projective capacitive touch screen as the user interface for the entry station 2 is particularly advantageous since it allows all of the working components to be positioned behind a glass facia 24 (or any suitable non-metallic material), thereby rendering the entry station weatherproof. Another advantage of the behind-glass configuration is that the interface 22 is less prone to vandalism than conventional key-pad door stations since vandals would need to break the glass pane (which can be anywhere up to 20 millimetres thick and laminated) in order to access and damage the internals.

In addition, by virtue of the fact that the interface 22 is in the form of a touch screen, can be designed to provide interactive navigation allowing visitors to navigate a directory or phone book. The interface can also be dynamically updated to provide up-to-date directory information, any number of required dialling/access functions, or to display any type of digital content (e.g. advertising, residence news, digital signage, etc.).

The hardware used to operate the entry terminal 2 is housed in a box 26 positioned behind the interface (see FIG. 2b).

The box 26 is made up of two sheet metal boxes (e.g. mild steel, powder coated) and a depth adjustment sleeve. The outer box (render box) 30 is designed to be mounted into a wall cavity and then rendered flush with the front surface of the wall. There are a number of punch-outs for giving various options to run cables into the box. At the time of installation, a depth adjustment sleeve 32 is fitted into the render box 30. This sleeve 32 has slots on the side wall so any shortcomings in the installation of the render box 30 can be overcome by adjusting the sleeve 32 and it's mounting to the render box 30. The sleeve 32 has two flat wings at the front which rest flat against the front surface of the finished wall. These wings act as a depth gauge and guide the installer in the mounting. The lower side of the depth adjustment sleeve has holes for cable access.

All electronics are mounted into an inner box (electronics box) 34 which is then mounted to the depth adjustment sleeve 32 using M5 screws. The electronics box 34 has two key-hole hooks at the top for attachment to the sleeve 32 in the mounting process. This assists the installer when he is doing the installation single handed. The electronics box 34 has vents 36 in the rear for assisting in air ventilation and keeping the electronics cool. The vents 36 are designed to be water resistant—balcony shaped vents—protruding outwards, facing down with vents on the underside. The electronics box 34 has a rubber seal around the front, outside edge. The rubber seal has approximately 3 cm of possible compression.

The boxes are designed to allow a flow of air through the rear of unit for cooling, any water that should enter into the housing 26 can escape through vents placed at the bottom—comes out the front between the render box 30 and the adjustment sleeve 32. The glass front 24 is then mounted to the wall using four stainless steel balustrade fixings. The glass 24 can be a standard size or it can be a custom piece of glass that is designed to complement the architecture of the entry or building.

The interface 22 is arranged to push hard-up against the glass 24 by way of the rubber seal and the spring mechanism that pushes a plate (not shown) on which the interface 22 is mounted outwardly away from the electronics box 26. Mounting the interface 22 hard against the glass 24 improves the accuracy and performance of the projected capacitive touch. The rubber rim mounted on the front side of electronics box provides the waterproof seal between the glass and the electronics.

The entry terminal 2 includes a combination of hardware and software for facilitating dialling, access and control functionality. In this regard, the entry terminal 2 comprises a processor which is arranged to run an operating system such as the Microsoft Windows XP™ (XPe) operating system. The operating system runs an entry application (in this embodiment written using .net technologies and the software developer kit available from Counterpath Corporation) which controls operation of the user interface and facilitates the placing of peer-to-peer calls to either an internal extension (i.e. residence terminal) or an external VOIP device, as will be described in more detail in subsequent paragraphs. The Counterpath software also provides a mixture of royalty-based and royalty-free codecs such as the H263, 263+ and 264 codecs (hereafter “video codecs”) and uLaw, aLaw (hereafter “audio codecs”). The codecs are required to successfully carry and display audio and video between the various devices/terminals coupled to the IP network.

As previously mentioned, the intercom system 1 also includes a communications system 3. In more detail, the communications system 3 includes a Session Initiated Protocol server (hereafter “SIP server”) 3a and Building Management Server (hereafter “BMS”) 3b.

The SIP server 3a has the primary function of routing calls, handling rules and messaging functionality. The SIP server negotiates codecs between peers, holds SIP Peer settings for all extensions and has the option of connection to Internet Telephony Service Providers (ITSP) and interfacing to analogue Plain Old Telephony Service (POTS). To carry out this functionality, the SIP server 3a includes standard server hardware and software (i.e. processor, motherboard, random access memory, hard disk, flash drive, etc.). The SIP server 3a also implements an embedded operating system (such as the Linux operating system) which co-operates with the hardware to provide an environment in which software applications can be executed. In this regard, the flash drive is loaded with the Asterisk private branch exchange (PBX) software (available from the Internet at URL: http://www.asterisk.org/) which is arranged to handle the routing of calls between various extensions (i.e. entry station, residence terminal, external VOIP device, etc). The software implements a customised user interface for configuration and video support. The asterisk software is also operable to host a series of rules for an extension, instructing routing information such as call forwarding or message bank details.

The other server implemented by the communications system is the BMS 3b. It will be understood that the BMS 3b can manage multiple Switch Control servers within a single project (i.e. residential complex, etc) depending on the size of the project. The BMS's primary function is to provide control for common area or public devices such as access control and to provide the interconnectivy between the servers in each residence. To achieve this functionality, the BMS 3b consists of the same basic hardware as the SIP server 3a (although in the presently described embodiment utilises the Linux operating system, as opposed to Microsoft XPe), but in addition comprises a management application which is programmed to facilitate the above-mentioned functionality.

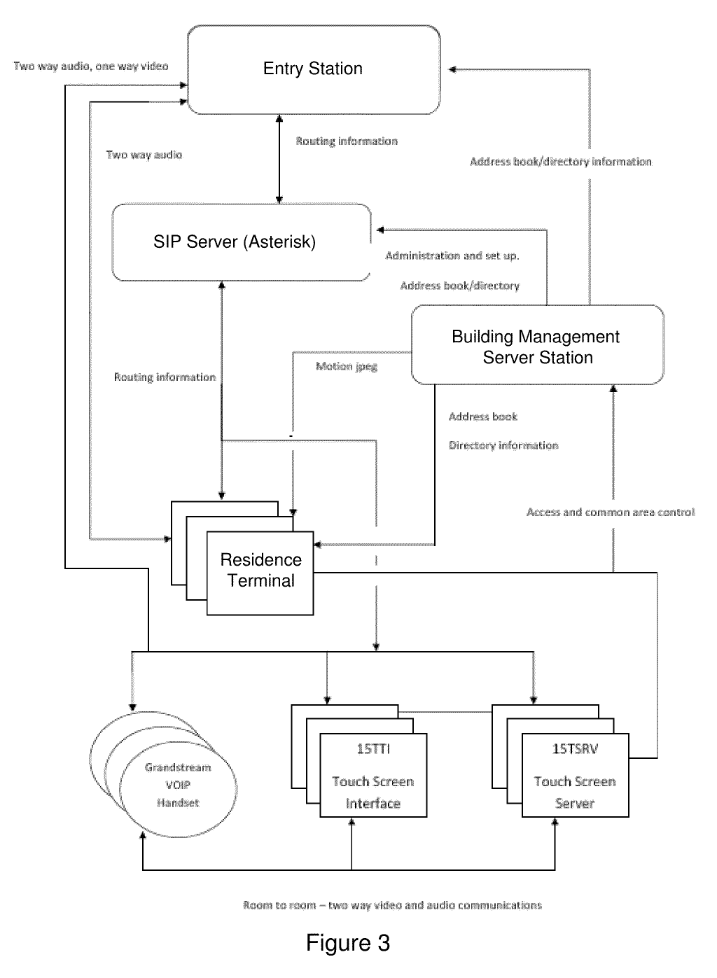

Each residence includes a residence terminal 5 in the form of a touch-screen display or VOIP handset including suitable hardware/software (in the illustrated example, hosting the Counterpath software, or Texas instruments Da Vinci or compatible chip) for communicating with the entry station 2, other residence terminals 5, or some external VOIP terminal, over the IP network. The terminals 5 may also include server software (as shown in FIG. 3) including a terminal application for controlling lighting, security, music, audio visual, and other networked devices within the associated residence. The terminal application can also control common area functionality such as access control for devices that are made publicly available by the BMS 3b.

Finally, non-residence terminals may also be coupled to the network for communicating with either the entry station 2 or residence terminals 5. The non-residence terminals each have the audio codecs and video codecs built into the terminal software so that they can communicate with each of the devices mentioned above.

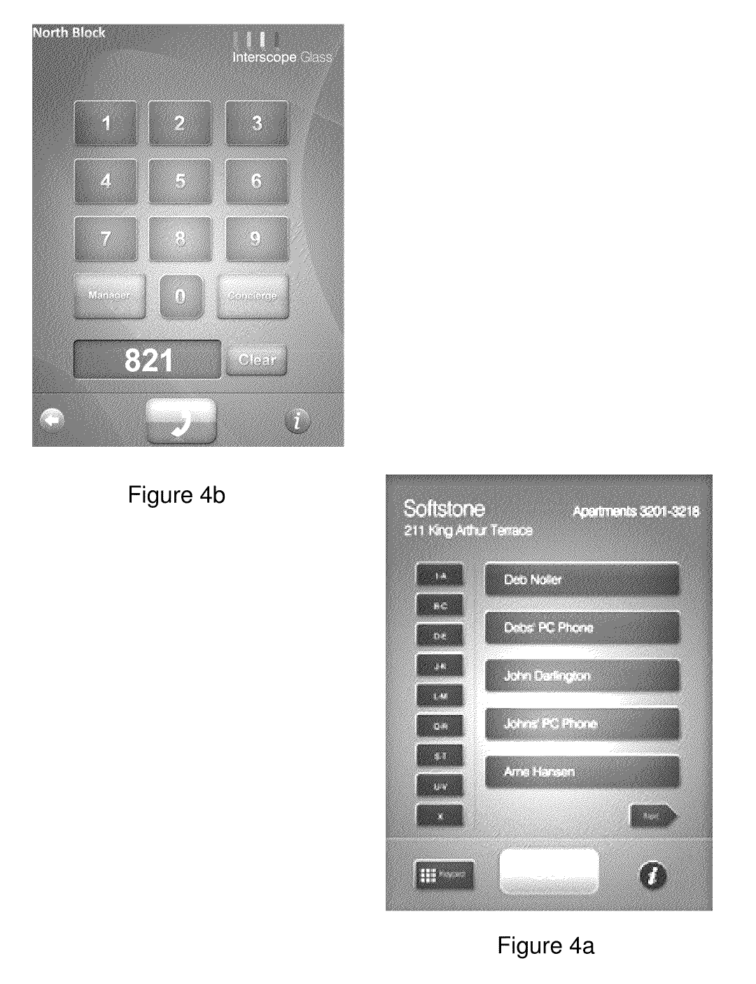

FIG. 3 shows a process flow diagram for placing calls and carrying out common area control. At the top of the screen is shown the entry station 2. As can be seen, the entry station 2 is operable to communicate with the management server 3b to allow a visitor to search and obtain address book and directory information for a particular residence extension, via the touch-screen interface. An example screen shot of the directory searching interface (i.e. providing identification information such as residents name, number, location, etc.) is shown in FIG. 4a.

Once the desired directory information has been obtained, the visitor can then place a call to the relevant residence extension (e.g. using the virtual keypad configuration shown in FIG. 4b). This is carried out by the entry application and involves placing a request with the SIP server 3a for routing information associated with the particular extension. The SIP server 3a looks up an address listing in memory and replies with the necessary routing information. This is then utilised by the Counterpath software to place a call to the particular extension in accordance with techniques known in the art (see the left hand side of the FIG. 3 flow diagram). If the call is not answered, the entry application can terminate the call and invoke an answer message procedure whereby the visitor can record an audio-visual message for the occupier of the residence.

The BMS 3b controls and communicates with the security or access control system 3c. All the rules and related programming for access control are programmed or configured into the BMS 3b. Each residence implements a residence server or handset that is SIP enabled and capable of carrying the video or audio call from the entry access point.

The residence servers can communicate directly with the BMS 3b to enact access control commands and other control such as common area lighting.

In the case of a SIP enabled handset, the receiver of the call can send DTMF tones via the keypad on the handset to the SIP server 3a. The SIP server then routes the DTMF tones to the BMS 3b and the BMS 3b translates that DTMF tone into a control command or series of control commands. The SIP server knows the origin and destination of every call and communicates this information to the BMS 3b in the DTMF messages. The BMS 3b then uses the call origin, call destination and access code to determine the series of control commands to run.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. An entry station for an intercom system, the entry station comprising:
a touch-screen user interface operable to facilitate a dialling function; and
a communications module arranged to communicate with at least one destination terminal in accordance with the dialling function.

2. An entry station in accordance with claim 1, wherein the touch-screen user interface comprises a projective touch-capacitive panel located behind a weatherproof shield.

3. An entry station in accordance with claim 2, wherein the water-proof shield is a sheet of glass.

4. An entry station in accordance with claim 1, wherein the communications module is further arranged to carry out a video and/or audio call with the at least one destination terminal over an IP network.

5. An intercom system comprising:
An entry station in accordance with claim 1; and
at least one destination terminal operable to communicate with the communications module over an IP communications network.
